(19) United States
(12) Patent Application Publication
(10) Pub. No.: US 2024/0228735 A1
(43) Pub. Date: Jul. 11, 2024

(54) Method for the Preparation of a Recycled Polymeric Material from Spent Coffee Capsules

(71) Applicants: CAFFE' TOSCANO S.R.L., Livorno (IT); ADDI' S.R.L., Livorno (IT)

(72) Inventors: Martino Colonna, Bologna (IT); Alessandro Nanni, Grosseto (IT)

(21) Appl. No.: 18/558,162

(22) PCT Filed: Apr. 29, 2022
(86) PCT No.: PCT/IB2022/053994

§ 371 Date: Oct. 30, 2023

(30) Foreign Application Priority Data
Apr. 29, 2021 (IT) 102021000010880

(51) Int. Cl. C08J 11/18; C08L 23/12

(52) U.S. Cl. CPC C08J 11/18; C08L 23/12; C08J 2323/12; C08L 2205/025; C08L 2207/20

(57) ABSTRACT

The present invention relates to a method for preparing a recycled polymeric material from spent coffee capsules by using them as a secondary raw material.

### FIELD OF THE INVENTION

The present invention relates to a method for preparing a recycled polymeric material from spent coffee capsules by using them as a secondary raw material.

### PRIOR ART

As is well known, the worldwide consumption of coffee capsules is dramatically increasing. We are talking about ten billion sales per year worldwide.

This is not surprising, given the high quality achieved, the many blends to choose from and the easy availability that the online market has given its users. However, this new market has generated more than 20,000 tonnes of waste, mostly consisting of plastic coffee capsules, which are certainly a very complicated type of waste to dispose of, as they cannot be separated.

The literature describes methods and devices for emptying, shredding or separating capsules into their respective components, i.e. spent plastic capsules and the organic component they contain, i.e. spent coffee, in an attempt to properly dispose of the different materials for separate collection, thus reducing their environmental impact.

For example. WO2014/135550 describes a device for opening the capsules consisting of a specific perforation system, WO2011/051867 describes a further system that operates the cutting and emptying of the capsules, with the possibility of recovering in two different containers the two residues of the separation, FR2944420 describes a complicated manual system for emptying and separating the coffee from the capsules, based on the use of a piston that, by pressing the capsule, helps the release of the coffee.

EP3250331, on the other hand, describes a scalable system capable of processing several capsules at the same time, with a perforated chamber in which the capsules are simultaneously shredded by means of blades connected to an impeller driven by an electric motor and the materials are separated.

The Applicant also recently filed an Italian patent application, application number 102020000011188, which describes a machine enabling the treatment of spent coffee capsules on an industrial scale, in particular a machine which carries out their shredding and separation into their components. This machine, unlike the machines described in the prior art, allows simple, effective and fast separation of the materials, which can be used on an industrial scale.

Although there are therefore descriptions in the literature of systems for separating the various materials that make up post-consumer spent coffee capsules, these methods, in the practice, would at most allow the disposal of the various components through correct collection and separate disposal practices of the various residues.

There are no known methods of reusing these residues to avoid the impact they would have on the environment even if properly disposed of, especially plastics, the disposal of which is now an international emergency.

The main difficulties for the reuse of these plastics are due to the fact that they have been subjected to thermal and mechanical stresses that have changed their properties, both during their use as protective and containment wrappers for coffee, and during the processes of separation from coffee once it has been used up.

In addition, the plastics used for capsules are of different types, so separate collection results in mixtures of different polymeric materials with different rheologies, which are difficult to process and also contain residues of other materials such as filter paper and coffee, the separation of which would be not only complicated but also uneconomic.

In fact, it is well known in the literature that current recycling technologies need to feed waste plastics that are as homogeneous as possible, as most plastics are not compatible with each other and therefore the resulting mixtures show very poor mechanical properties (Garcia, J. M. and M. L. Robertson, The future of plastics recycling; Science 2017, 358 (6365), p.870-872).

Even small contaminations of one type of plastic with another can have a considerable impact on the final properties of the resulting recycled polymeric mixture, severely limiting its potential uses. Therefore, time-consuming and costly sorting of the various waste plastics entering the recycling processes is often necessary, leading to high increases in the price of the final recycled material (Patel, M. et al., Recycling of plastics in Germany; Resources, Conservation and Recycling, 2000; 29 (1-2), p.65-90).

In this logic, for example, IN201641015805 describes the possibility of reusing the plastic materials that make up spent coffee capsules, after separating them from their contents, granulating and drying them, to make polymeric materials wherein these plastics are added with spent coffee, which has also been pre-treated with dehumidification systems. The resulting polymers have good mechanical properties for possible further use, but clearly suffer from poor industrial feasibility due to the many operations required to generate them, which make a material which in itself is of little value, such as recycled polymer, completely uneconomic. Identically, in Shayene Campos de Bomfim, A. et Al, Journal of Cleaner Production, Elsevier Amsterdam, Vol. 297, 2021, spent coffee capsules are washed with plenty of water to help the separation of the components, then dried for 24 hours in an oven at 60° C. and ground, before being mixed with spent coffee, which has also been dried for 48 hours at 60° C., ground and sieved.

The Applicant points out that these methods are not industrially competitive, as they are very resource-intensive (heat, water) in terms of the pre-treatment steps required before the plastics can be reused.

Therefore remains unresolved the problem of finding an alternative way to dispose of plastics obtained from the separation of spent coffee capsules, which also contain residues of other components such as paper and coffee, in order to reduce their environmental impact and allow them to be used in industrial supply chains for further use, according to the logic of the circular economy, and at the same time to simplify processes, and therefore costs, given the lower economic value generally attributed to materials from recovery processes, compared to so-called “virgin” materials.

The aim of the present invention is therefore to solve the problems left open by the known technique.

### SUMMARY OF THE INVENTION

The scope of the invention was achieved by a method for the preparation of a recycled polymeric material from spent coffee capsules by using them as a secondary raw material.

Surprisingly, the inventors of the present invention found that, contrary to the indications and suggestions in the state of the art, the spent coffee capsules, after simple and coarse shredding and removal of a part of the coffee contained therein, and without any further treatment such as washing or drying, could be directly subjected together with all their residues, consisting of coffee, paper, one or more types of plastics and, sometimes, aluminium, and after the addition of a coupling agent, to a recycling process for the formation of new manufactured articles.

Therefore, the material consisting of a shredded spent coffee capsules and its residues, such as one or more types of plastic, paper and/or aluminium and coffee present in an amount from 5 to 70% by weight with respect to the total weight of the material, could constitute an excellent material for the production of a recycled polymeric material.

In particular, said material is preferably obtained by shredding spent coffee capsules in which the capsule body is made of polypropylene.

Thus, in a first aspect, the present invention relates to a method for the preparation of a recycled polymeric material comprising the steps of:
(a) preparing a material obtained by shredding spent coffee capsules comprising polypropylene particles, coffee in an amount from 5 to 70% by weight, with respect to the total weight of the material, and particles of at least one residue selected from the group consisting of: paper, one or more polymers other than polypropylene, aluminium, and mixtures thereof;
(b) mixing the material from step (a) with at least one coupling agent thus obtaining the recycled polymeric material.

The Applicant has in fact surprisingly found that by mixing said material obtained from spent coffee capsules with a coupling agent it is possible to reuse the spent coffee capsules for the preparation of a recycled polymeric material.

In other words, the present invention relates, in a first aspect, to a use of a material obtained by shredding spent coffee capsules comprising polypropylene particles, coffee in an amount from 5 to 70% by weight with respect to the total weight of the material, and particles of at least one residue selected from the group consisting of paper, the one or more polymers other than polypropylene, aluminium, and mixtures thereof, as a secondary raw material for the preparation of a recycled polymeric material, wherein said preparation comprises the step of mixing said material with at least one coupling agent.

According to an advantageous aspect of the method of the invention, in step b), at least one polypropylene having a maximum tensile strength in the range from 15 to 45 MPa is also added.

Thanks to the method according to the present invention, it is therefore possible to promote the separate collection and allow an efficient recycling of the spent coffee capsules, so as to obtain a recycled plastic material able to be then reinserted into the production chain of various manufactured articles such as, for example, molded articles such a capsule for dispensing a drink, a container, a jar, a cutlery, a plate, a cap, a lid.

In a further aspect, the present invention relates to a recycled polymeric material comprising a matrix (continuous phase) comprising polypropylene from spent coffee capsules coupled with at least one coupling agent, and a dispersed phase comprising spent coffee particles and particles of at least one residue selected from the group consisting of: paper, one or more polymers other than polypropylene, aluminium, and mixtures thereof.

In a still further aspect, the present invention also relates to a recycled polymeric material comprising a matrix (continuous phase) comprising polypropylene from spent coffee capsules coupled with at least one coupling agent, at least one polypropylene having a maximum tensile strength in the range from 15 to 45 MPa, and a dispersed phase comprising spent coffee particles, and at least one residue selected from the group consisting of paper, one or more polymers other than polypropylene, aluminium, and mixtures thereof, as well as to a manufactured article made from said polymeric material.

The advantages and characteristics of the polymeric material according to the present invention and of the article made therefrom have already been outlined with reference to the method according to the first aspect of the invention and are not repeated here.

### BRIEF DESCRIPTION OF THE DRAWINGS

FIG. 1 shows the image of a sample of a coffee capsule, injection molded and obtained using both the EP 30PP 2PPgMA composite referred to in Example 2 (image b) and the PP INJ composite referred to in Example 1 (image a).

FIG. 2 shows an image of a jar sample obtained with the EP 40SGC 2PPgMA composition of Example 4, viewed from above (image a) and from the side (image b).

### DETAILED DESCRIPTION OF THE INVENTION

In a first aspect, the present invention relates to a method for preparing a recycled polymeric material comprising the steps of:
(a) preparing a material obtained by shredding spent coffee capsules comprising polypropylene particles, coffee in an amount from 5 to 70% by weight, with respect to the total weight of the material, and particles of at least one residue selected from the group consisting of: paper, one or more polymers other than polypropylene, aluminium, and mixtures thereof;
(b) mixing the material from step (a) with at least one coupling agent thus obtaining the recycled polymeric material.

Preferably said material obtained by shredding spent coffee capsules comprises coffee in an amount from 10 to 50% by weight with respect to the total weight of the material.

Preferably said one or more polymers other than polypropylene are selected from the group consisting of: polyethylene (PE), polyethylene terephthalate (PET), polybutylene terephthalate (PBT), a polyester other than PET and PBT, and ethylene-vinyl alcohol copolymer (EVOH).

Commercial coffee capsules are made in different ways, for example, depending on whether or not they are contained in plastic bags for storage.

So-called self-protected capsules, which are not contained in plastic bags, typically consist of a polybutylene terephthalate (PBT) body and an aluminium or multilayer foil sealant, i.e. a polyethylene/polyester/aluminium laminate, to prevent oxygen from passing through them and flavours from escaping.

Capsules marketed instead in bags typically consist of a polypropylene (PP) body, a lid made of a polyethylene/polypropylene/polyethylene terephthalate or polypropylene/polyester laminate, and often paper filters arranged within them to prevent the escape, during the dispensing, of coffee powder into the beverage. These particular capsules, preferably, are treatable according to the method of the invention, therefore the plastic fragments constituting their film as well as the fragments of the paper filters, if any, remain dispersed in the material obtained by shredding them.

There are also capsules made of an aluminium body, which are not discussed below as they are outside the scope of the present invention, since they follow alternative recycling routes for the recovery and reuse of the metal they contain.

The Applicant has therefore surprisingly found that by directly mixing the material obtained by shredding the spent coffee capsules having the capsule body made of plastic material, preferably polypropylene, with a coupling agent, it is possible to reuse the spent coffee capsules for the preparation of a recycled polymeric material.

This method is particularly advantageous in that it allows the plastic materials resulting from the separation of spent coffee they contain to be used, as they are obtained from the separation process, i.e. soiled with varying amounts of spent coffee, as well as other polymeric, paper or metal components, without having to carry out any kind of cleaning treatment on them before they are recycled.

This allows a considerable simplification at industrial level of the recycling operations since it is not necessary to carry out, as the state of the art considers necessary, long and costly separations of the components, washing and drying of the same, as well as the grinding and sieving of the spent coffee before adding it to the polymeric recycling mixture, as indispensable operations before extruding the mixture.

Said simplification therefore results into a clear saving of resources and costs at industrial level and therefore into greater feasibility of the operation to recycle spent coffee capsules, which until now has never been carried out due to its uneconomic nature, also considering the lower economic value attributed by the market to recycled materials compared to virgin materials.

The mechanical and rheological processing properties of the recycled polymeric materials thus obtained, as will be clear from the experimental part that follows, have proved to be comparable, if not even superior, to those obtainable according to known art, starting from plastics subjected to meticulous processes of separation, washing, cleaning and drying.

In other words, the present invention relates in a first aspect to a use of a material obtained by shredding spent coffee capsules comprising polypropylene particles, coffee in an amount from 5 to 70% by weight with respect to the total weight of the material, and particles of at least one residue selected from the group consisting of: paper, one or more polymers other than polypropylene, aluminium, and mixtures thereof as a secondary raw material for the preparation of a recycled polymeric material, wherein said preparation comprises the step of mixing said material with at least one coupling agent.

Thanks to the method according to the present invention, it is therefore possible to promote the separate collection and allow an efficient recycling of the spent coffee capsules, so as to obtain a recycled plastic material able to be then reinserted into the production chain of various manufactured articles such as, for example, molded articles such as a capsule for dispensing a drink, a container, a jar, a cutlery, a plate, a cap, a lid.

Within the scope of the present description and in the subsequent claims, all numerical magnitudes indicating quantities, parameters, percentages, and so on are to be understood in all circumstances to be preceded by the term “about” unless otherwise indicated. Furthermore, all ranges of numerical magnitudes include all possible combinations of maximum and minimum numerical values and all possible intermediate ranges, in addition to those specifically indicated below.

The present invention may have in one or more of its aspects one or more of the preferred features set out below herein, which may be combined with each other according to application requirements.

The method according to the present invention comprises the step a) of preparing a material obtained by shredding spent coffee capsules comprising polypropylene particles, coffee in an amount form 5 to 70% by weight with respect to the total weight of the material, and particles of at least one residue selected from the group consisting of: paper, one or more polymers other than polypropylene, aluminium, and mixtures thereof.

Preferably said at least one material obtained by shredding spent coffee capsules, comprises spent coffee powder with a moisture content from 0.1 to 2% by weight.

Advantageously said spent coffee powder comprises spent coffee particles with an average diameter from 0.2 to 0.7 mm.

Preferably, such spent coffee powder has an apparent density from 0.3 to 0.6 g/cm³.

Said at least one material obtained by shredding spent coffee capsules can be obtained from any type of polypropylene spent coffee capsule.

Advantageously, said material is a shredded material obtained by the steps of:
shredding a plurality of spent coffee capsules, and
separating a plurality of shredded spent capsules from a spent coffee, so as to obtain a material containing coffee in an amount from 5 to 70% by weight with respect to the total weight of the material.

Advantageously, said material is the shredded material obtained by means of the machine described in Italian patent application number 102020000011188 of the Applicant.

Other materials may also be added to said material.

For example, non-spent coffee, that may be obtained as a waste product from industrial capsule packaging lines, can also be added to said material.

In an advantageous embodiment of the invention, said material comprises up to 2% by weight of paper.

Said material can further contain small amounts of aluminium, usually less than 2% by weight.

Preferably, said material comprises from 0.1 to 25.0% by weight of at least one polymer other than polypropylene, such as polyethylene (PE), polyethylene terephthalate (PET), polybutylene terephthalate (PBT), a polyester other than PET and PBT, or ethylene-vinyl alcohol copolymer (EVOH), more preferably from 0.1 to 3% by weight.

These polymeric materials can be used to make the lid, i.e. the protective film that seals the capsule, preventing the coffee from coming into contact with the air, or they are mixed with polypropylene to make the base or the capsule casing.

In an advantageous embodiment of the invention the at least one material comprises from 60 to 95% by weight of polypropylene particles from spent coffee capsules, from 5 to 40% by weight of spent coffee powder, paper in an amount up to 2% by weight and optionally at least one polymer other than polypropylene in an amount form 0.1 to 25.0% by weight, preferably from 0.1 to 3% by weight.

In a further advantageous embodiment of the invention, said material is directly derived from shredding operations of spent coffee capsules, such as those achievable by means of the machine described in patent application number 102020000011188. without any chemical or physical pre-treatment before its use according to the method of the invention, and therefore said material may also comprise paper, if the shredded spent capsules originally contain paper filters, and/or polymers other than polypropylene if said capsules have protective films (lid) or wrappers made of polymeric materials other than polypropylene, or aluminium when used for its components.

In fact, the Applicant has surprisingly found that the presence of said residues in the recycled material obtainable by the method according to the present invention is not such as to compromise the mechanical and processing properties of the polymeric material, thus making it possible not necessarily involving costly and time-consuming operations of separation and purification of the polymeric fraction of the spent capsules in order to allow their subsequent processing according to the method of the invention.

In a further aspect, the present invention therefore also relates to a recycled polymeric material comprising a matrix (continuous phase) comprising polypropylene from spent coffee capsules coupled with at least one coupling agent, and a dispersed phase comprising spent coffee particles and at least one residue selected from the group consisting of paper, one or more polymers other than polypropylene, aluminium, and mixtures thereof, as well as its use as a secondary raw material for making a recycled polymeric material.

In a preferred embodiment said material comprises from 5 to 70% by weight of spent coffee, more preferably from 10 to 50%.

In an even more preferred embodiment, said material comprises from 50 to 95% by weight of polypropylene particles from spent coffee capsules, from 5 to 50% by weight of spent coffee powder, paper in an amount of up to 2% by weight and, even more preferably, at least one polymer other than polypropylene, such as for example PE, PET, PBT, a polyester other than PET and PBT, or EVOH in an amount from 0.1 to 25.0% by weight, preferably from 0.1 to 3% by weight, and it is advantageously used as a secondary raw material for making a recycled polymeric material.

The method according to the present invention comprises the step b) of mixing the material of step a) with at least one coupling agent, so as to obtain the recycled polymeric material.

Preferably, in said step b) the amount of said at least one coupling agent varies from 0.5 to 4.5% by weight, with respect to the total weight of the at least one material of step a), preferably is about 2% by weight.

Preferably, said at least one coupling agent is selected from the group consisting of a silane or a polymer functionalized with maleic anhydride or with methacrylate glycides.

Preferably said silane is selected from the family of amino-silanes, including 3-aminopropyltriethoxy-silane [CAS Number: 919-30-2], N-(2-Aminoethyl)-3-aminopropyltrimethoxy-silane [CAS Number: 1760-24-3], 3-(2-Aminomethylamino)propyltriethoxy-silane [CAS Number: 5089-72-5] and/or from the family of vinyl silanes, including vinyltrimethoxy-silane [CAS Number: 2768-02-7], vinyldimethoxymethyl-silane [CAS Number: 16753-62-1], vinyltriethoxy-silane [CAS Number: 78-08-0] and vinyltriacetoxy-silane [CAS Number: 4130-08-9].

Preferably said polymer functionalized with maleic anhydride or with methacrylate glycides is polypropylene functionalized with maleic anhydride.

More preferably, said at least one coupling agent is 3-aminopropyltriethoxy-silane or polypropylene functionalized with maleic anhydride.

In a further aspect, the present invention thus also relates to a recycled polymeric material comprising a matrix (continuous phase) comprising polypropylene from spent coffee capsules coupled with at least one coupling agent, and a dispersed phase comprising spent coffee particles and at least one residue selected from the group consisting of: paper, one or more polymers other than polypropylene, aluminium, and mixtures thereof.

In a preferred embodiment of the invention, said recycled polymeric material comprises a matrix (continuous phase) comprising polypropylene from spent coffee capsules coupled with at least one coupling agent, wherein the weight ratio of polypropylene:coupling agent is in the range from 50:4.5 to 95:0.5, and a dispersed phase comprising spent coffee particles in an amount from 5 to 70% by weight, preferably from 10 to 50%.

In an advantageous embodiment of the method according to the invention, at least one polypropylene having a maximum tensile strength in the range from 15 to 45 MPa is also added in said step b).

In the present invention, the words maximum tensile strength and yield strength may be used interchangeably, almost synonymously in the particular case of the polypropylene polymer.

The inventors surprisingly found that the addition of at least one polypropylene with a maximum tensile strength in the range from 15 to 45 MPa makes it possible to obtain a recycled polymer material with better properties in terms of industrial workability and thus processability.

Said at least one polypropylene having a maximum tensile strength in the range from 15 to 45 MPa may be pure polypropylene or polypropylene blended with other polymers, virgin or recycled.

Preferably said at least one polypropylene having a maximum tensile strength in the range from 15 to 45 MPa is added in step b) of the method according to the present invention in an amount from 30 to 60% by weight with respect to the total weight of the material comprising polypropylene particles from spent coffee capsules referred to in step a).

In a further aspect, the present invention also relates to a recycled polymeric material comprising a matrix (continuous phase) comprising polypropylene from spent coffee capsules coupled with at least one coupling agent, at least one polypropylene having a maximum tensile strength in the range from 15 to 45 MPa, and a dispersed phase comprising spent coffee particles and at least one other residue selected from the group consisting of: paper, one or more polymers other than polypropylene, aluminium, and mixtures thereof.

Advantageously, said recycled polymeric material comprises from 30 to 60% by weight with respect to the total weight of said polypropylene material having a maximum tensile strength in the range from 15 to 45 MPa.

Said recycled polymeric material has proved to be particularly suitable, in terms of processability and industrial workability, for use in the manufacture of various manufactured articles.

In step b) of the method according to the invention, one or more further components which are routinely used in the processing of plastics and in particular in the processing of polypropylene-based plastics, such as, for example, fillers, colorants, sliding agents, may also be advantageously added.

Silver skin, a waste by-product of the coffee industry generated by the roasting of coffee beans and now disposed of as organic waste, can be used preferably as a filler, so that value is also given to this waste and the recycling method can be made even more virtuous according to the logic of the circular economy.

Step b) of the method according to the present invention may be carried out in one or more apparatuses for the production of a polymeric material, such as a static mixer or an extruder.

Preferably, said step (b) is carried out at a temperature from 160 to 220° C.

In an embodiment, said step b) is carried out in a static mixer operating at 30 to 100 rpm, preferably 50 rpm, and preferably for a time in the range from 3 to 9 minutes, preferably 6 minutes.

In a further embodiment, said step b) is carried out in a single- or twin-screw extruder.

Thanks to the method according to the present invention, it is therefore possible to obtain a recycled polymeric material suitable for being reintroduced into the production chain of various manufactured articles, thus helping the separate collection of spent coffee capsules and so allowing an efficient recycling thereof.

In a further aspect, the present invention therefore also relates to a recycled polymeric material obtainable by the method according to the first aspect of the invention.

The advantages and characteristics of the recycled polymer material according to the present invention have already been shown with reference to the method according to the first aspect of the invention and are not repeated here.

In a further aspect, moreover, the present invention relates to an article made from the polymeric material according to the present invention, selected from the group consisting of: a molded article, preferably an injection molded article, a granule, a pellet, a wire, a film, and a coil.

Preferably, said molded article is selected from the group consisting of: a capsule for dispensing a drink, a container, a jar, a cutlery, a plate, a cap, a lid.

Due to the rheological, thermal and processability properties, the polymeric material according to the present invention is usable in any process for treating plastics, in order to obtain a molded article.

As will be evident from the results obtained in the detailed experimentation that follows, in particular with reference to Example 4, the recycled material according to the invention even made it possible to mold articles with components less than 1 mm thick, in total contrast to what is taught by the known technique.

In a further aspect, the present invention therefore also relates to a process for the preparation of a molded article comprising the steps of:
preparing a recycled polymeric material according to the present invention, and
molding said recycled polymeric material.

Preferably, this molding step is carried out by injection molding.

The molded article obtainable by said process is preferably selected from the group consisting of: a capsule for dispensing a drink, a container, a jar, a cutlery, a plate, a cap, a lid.

The invention is now illustrated by means of some Examples which are intended to be illustrative and not limiting of the invention.

### Experimental Part

### Methods

Moisture content: The moisture content of the spent coffee was determined by oven-drying 500 g of spent coffee powder at 80° C. to constant weight.

Apparent and real density: The apparent density (ρapp) was measured by reading the volume occupied by 5 g of spent coffee powder inside a 50 mL graduated cylinder, and the real particle density (ρp) was determined in the same way by subjecting the spent coffee powder to a load of 100 N.

Average diameter: the average particle diameter size of the spent coffee powder (dp) was measured by sieving 100 g of spent coffee with 5 standard sieves: 1.41 mm (No. 14), 1 mm (No. 18), 0.5 mm (No. 35), 0.21 mm (No. 70) and 0.125 mm (No. 120) and weighting the amount of spent coffee retained by each sieve. Therefore, the average diameter (d̅p) was determined according to formula (1):

$${d}_{p} = {\sum }_{i = 1}^{4} \frac{( {d}_{i} + {d}_{i + 1} )}{2} * {ω}_{i + 1} \qquad ( 1 )$$

where di represents the mesh diameter of the sieve and wi is the weight fraction deposited on it (i=1 refers to the highest mesh diameter, 1.41 mm).

Thermogravimetric analysis: Thermogravimetric analysis (TGA) was performed using Perkin-Elmer TGA 4000 with a min-1 flow of 40 mL of nitrogen atmosphere. Tests were conducted on 10±2 mg of sample using a ramp temperature of 10° C. min⁻¹ from 30° C. to 600° C. From the thermograms, the residue content at 600° C. (R600) and the peak temperature (Tpeak) were extrapolated. Tpeak is the temperature at which the maximum of the derivative of weight versus time (DTA) is observed.

Mechanical characterisation: Tensile tests were carried out using an INSTRON 5966 dynamometer equipped with a 10 kN load cell. The tests were conducted at room temperature using a clamp separation speed of 10 mm min⁻¹. The values of Young's modulus (E), maximum tensile strength (σ) and elongation at break (ε) were calculated as the average of at least five determinations.

Melt Flow Rate (MFR): The MFR was determined in accordance with ISO 1133, using a load of 2.16 kg and a temperature of 190° C.

### Example 1

About 300 coffee capsules from Espresso Point product line by Caffè Toscano Srl were used for this experimental test.

Espresso Point capsules contain a variety of materials in addition to the coffee: they have a polypropylene casing (specifically a pure, virgin blend of two polypropylenes of different grades), a lid consisting of a laminated polypropylene and polyester film and a filter paper base.

In terms of composition, the capsule, prior to use, consists of:
a polypropylene body (mixture of two different polypropylenes) weighing 4 g (corresponding to 36.1% by weight of the capsule weight);
a lid made of a polypropylene/polyester laminate weighing 0.05 g (corresponding to 0.5% by weight of the capsule weight);
a paper filter weighing 0.02 g (corresponding to 0.2% by weight of the weight of the capsule);
coffee in the amount of 7 g (corresponding to 63.2% by weight of the weight of the capsule).

After using the capsules, i.e. after the normal dispensing of the coffee contained therein, such post-consumption spent capsules were fed to a machine according to the example of the Applicant's Italian patent application number 102020000011188, resulting in shredded material and spent coffee.

The spent coffee was then analysed to determine its moisture content, apparent and real density, average diameter, residue content at 600° C. and peak temperature (Tpeak) according to the methods described above in the “Methods” section. Table 1 shows the results obtained.

TABLE 1

| | |
|---|---|
| Average particle diameter [mm] | 0.54 ± 0.16 |
| Initial moisture content [%]. | 5.9 ± 0.4 |
| Apparent density [g/cm³] | 0.39 ± 0.02 |
| Real Density [g/cm³] | 0.51 ± 0.01 |
| Residue content at 600° C. [%]. | 28.2 |
| Tpeak [° C.] | 307.6 |

The shredded material obtained after separation from the spent coffee, consisting of fragments of polypropylene, polyester, filter paper and spent coffee, contained about 87.30% by weight of polypropylene, about 11.72% by weight of spent coffee, about 0.43% by weight of filter paper and about 0.55% by weight of polyester.

Several composites were made from this shredded material (denoted EP), either by adding two different coupling agents, namely polypropylene grafted with maleic anhydride (PPgMA), commercial product Polybond 3200 sold by Chem Point, or 3-aminopropyltriethoxy-silane (SIL), commercial product sold by Acros Organics, or varying amounts (10 and 20% by weight) of additional spent coffee ground (SCG) from the same separation process.

The performance of all the composites was also compared with the performance of two reference composites: the first one made of the same commercial virgin polypropylene blend used for the production of Espresso Point casings (denoted PP INJ) and the second one made of this latter composite reground and reprocessed to simulate the shredding process (denoted PP recycled).

The compositional details of all tested composites are given in Table 2 below:

TABLE 2

| Sample name | Composition |
|---|---|
| PP INJ | Blend of the two types of virgin polypropylene used to make |
| | the injected molded Espresso Point capsule bodies |
| PP recycled | INJ PP specimens reground and reprocessed to simulate |
| | degradation due to the shredding process |
| EP | Shredded spent Espresso Point capsules after recovery and |
| | shredding with machinery referred to in patent application no. |
| | 102020000011188, consisting of the residues of the plastic |
| | materials of the casing and of the lid, of the residues of the |
| | paper filter and of the residues of spent coffee (as per the |
| | above composition, containing in particular 11.72% of spent |
| | coffee) |
| EP 2PPgMA | EP + 2% by weight of PPgMA |
| EP 2SIL | EP + 2% by weight of SIL |
| EP 10 GSC | EP + 10% by weight of SGC |
| EP 10 SGC 2PPgMA | EP + 10% by weight of SGC + 2% by weight of PPgMA |
| EP 10 SGC 2SIL | EP + 10% by weight of SGC + 2% by weight of SIL |
| EP 20 SGC | EP + 20% by weight of SGC |
| EP 20 SGC 2PPgMA | EP + 20% by weight of SGC + 2% by weight of PPgMA |
| EP 20 SGC 2SIL | EP + 20% by weight of SGC + 2% by weight of SIL |

The composites were made with an internal twin-screw mixer operating at a temperature of about 200° C. for a time of 6 minutes and a screw speed of 50 rpm.

The materials thus obtained were again granulated into pellets and fed to an injection molding machine (Mega Tech Tecnica DueBi) to obtain dog-bone specimens (type 1BA, ISO 527) for tensile testing, dynamic-mechanical analysis and rheological analysis (MFR).

The results obtained are summarised for the different samples in Table 3 below.

TABLE 3

| | | Maximum | Elongation | |
|---|---|---|---|---|
| | Young's | tensile | at break | Melt Flow |
| | modulus (E) | strength | (ε) | Rate (MFR) |
| Sample | [MPa] | ([Mpa] | [%] | [g/10′] |
| PP INJ | 707 ± 30 | 28.0 ± 0.5 | 316 ± 34 | 9.1 ± 0.5 |
| PP recycled | 719 ± 14 | 25.2 ± 1.9 | 67 ± 13 | 10.8 ± 0.4 |
| EP | 745 ± 19 | 21.9 ± 1.0 | 13 ± 2 | 17.4 ± 0.5 |
| EP 2PPgMA | 732 ± 8 | 24.0 ± 0.7 | 14 ± 1 | 16.0 ± 0.4 |
| EP 2SIL | 729 ± 15 | 24.6 ± 0.8 | 17 ± 3 | 16.2 ± 0.4 |
| EP 10SGC | 789 ± 9 | 20.0 ± 0.5 | 11 ± 1 | 13.8 ± 0.6 |
| EP 10SGC 2PPgMA | 807 ± 11 | 23.7 ± 0.5 | 9 ± 1 | 14.0 ± 0.3 |
| EP 10SGC 2SIL | 803 ± 8 | 21.5 ± 0.6 | 8 ± 1 | 12.9 ± 0.4 |
| EP 20SGC | 841 ± 26 | 17.7 ± 0.6 | 8 ± 1 | 11.4 ± 0.3 |
| EP 20SGC 2PPgMA | 900 ± 30 | 23.1 ± 0.5 | 6 ± 1 | 11.2 ± 0.4 |
| EP 20SGC 2SIL | 875 ± 19 | 19.0 ± 0.6 | 8 ± 2 | 11.3 ± 0.5 |

The obtained results showed that:
PP recycled exhibited a worsened profile of its mechanical and rheological properties compared to PP INJ, demonstrating the actual influence of the treatment processes on the degradation of the material; it should also be considered that the PP recycled sample had actually undergone only part of the degradation processes to which coffee capsules are subjected during their life cycle, therefore it is to be expected that the plastic materials of the capsules are even more degraded under real conditions; in particular, it is more than reasonable to consider that the possible pure polymer, obtained at the end of a real commercial life cycle of the capsule and after the various treatment steps, i.e. separation and purification from impurities, in the light of the data, would show even poorer values of the mechanical properties and definitely higher MFR values (even above 20 g/10′);
EP showed, surprisingly, absolute values of the various parameters related to the mechanical and rheological properties, despite the deterioration compared to the values of PP INJ, such as to allow its use for a variety of purposes, since this drop in performance is still compatible with the performance required for plastic materials in various applications;
the addition of the coupling agents PPgMA and SIL had a positive effect on the PE matrix, partly compensating for the drop in performance and therefore partly increasing the absolute values of the various quantities observed;
the further addition of spent coffee in the formulations in combination with the presence of the coupling agent led to a clear increase in mechanical performance, especially with regard to Young's modulus, which became increasingly pronounced as the added coffee content increased (compare the data for EP 10SGC 2PPgMA and EP 10SGC 2SIL with an additional 10% of spent coffee with those for EP 20SGC 2PPgMA and EP 20SGC 2SIL with an additional 20% of spent coffee);
the further addition of coffee made it possible, in particular, to improve the rheological properties of the material, as evidenced by the Melt Flow Rate value, a quantity that represents an index of the degradation of the polymer chains and therefore an index of the greater or lesser ease of processability/workability (in particular, as the degradation of the chains increases, the MFR increases, since the composite is less and less viscous, and therefore more fluid, due to the decrease in its average molecular weight, and therefore its properties in terms of industrial processability worsen); moreover, it was observed that the MFR value, which increased from the virgin polymer PP INJ to its processed (and degraded) PP recycled, up to the real recycled EP, decreased more and more with the increase of the coffee content, reaching values even comparable to those of the virgin polymer PP in the case of the sample with an additional 20% of spent coffee content;
the coupling agent PPgMA gave, in all prepared composites, a higher performance than the SIL agent.

This experimentation thus demonstrated that the mechanical and rheological properties of the composites obtained directly from the separation of the plastics of the spent capsules, with the addition of coupling agents and optionally including an amount of further spent coffee, were entirely comparable to, and indeed sometimes even better than, those of the pure plastics that would have been obtained after the treatment and cleaning cycles of the separated plastics. Processability, for example, which in the case of the composite with additional 20% of spent coffee, showed an impressive recovery in terms of MFR, even bringing it back to values in the range of 11-14 g/10′, i.e. values that are largely acceptable from an industrial point of view for its processability.

### Example 2

In this test, the composite material was produced using a twin-screw extruder in order to test an equipment frequently used on an industrial scale.

To improve the processability of the composite, virgin polypropylene was added to the polymeric material separated from the spent capsules.

Specifically, 68 parts by weight of shredded material EP according to Example 1, obtained by shredding Espresso Point capsules with the machine referred to in Italian patent application no. 102020000011188, were mixed with 2 parts by weight of polypropylene functionalized with maleic anhydride PPgMA (product Polybond 3200 sold by Chem Point), and 30 parts by weight of virgin polypropylene (PP INJ) having a maximum tensile strength value of about 28 MPa (sample denoted EP 30PP 2PPgMA). The final composite EP 30PP 2PPgMA thus obtained contained approximately 7.5% by weight of spent coffee.

The extrusion was carried out at a temperature of 200° C., over a time of 6 minutes and at a screw speed of 50 rpm.

The polymeric material was subjected to mechanical and rheological characterisation and compared with the samples tested in Example 1.

For the mechanical characterisation, the materials were molded in the form of specimens and then tested for Young's Modulus (E), maximum Tensile Strength (TS) and elongation at break (ε), while for the rheological characterisation, the MFR was determined according to the methods described above in the “Methods” section.

Table 4 shows the results obtained.

TABLE 4

| | E | σ | ε | MFR |
|---|---|---|---|---|
| Sample | [MPa] | [Mpa] | [%] | [g/10′] |
| EP 30PP 2PPgMA | 789 ± 42 | 25.7 ± 0.7 | 23.9 ± 5.6 | 12.6 ± 0.1 |

As can be seen, this composite also exhibited very good mechanical and rheological properties, despite containing a lower percentage of spent coffee.

### Example 3

The composite EP 30PP 2PPgMA from Example 2 was also used for the manufacture of a new coffee capsule using a twin-screw extruder and injection molding equipment. The processing conditions were compared with those for the preparation of a similar capsule based on a virgin polymer only, PP denoted PP INJ in Example 1.

These are the working conditions in the case of the sample EP 30PP 2PPgMA:
Plasticising screw Temp.: 208° C.
Injection chamber Temp.: 202° C.
Injection nozzle Temp.: 195° C.
Dosing: 27.5 mm
Cooling time: 7 s
Injection pressure: 70 bar
First injection time: 3.5 s
Injection speed: 66 mm/s
Holding pressure: 35 bar
Holding time: 3 s
Cooling time: 4 s

In the case of the PP INJ sample, the same working conditions were used for all parameters with the exception of the temperature parameters that, to allow the processability of the material, were as follows:
Plasticising screw Temp.: 220° C.
Injection chamber Temp.: 215° C.
Injection nozzle Temp.: 210° C.

It should be noted that in the case of the EP 30PP 2PPgMA material, it was even possible to carry out the molding at temperatures that were overall about 12-15° C. lower than the molding carried out on the PP INJ material based on virgin PP, which definitively demonstrates the excellent processability properties of the composite of the invention.

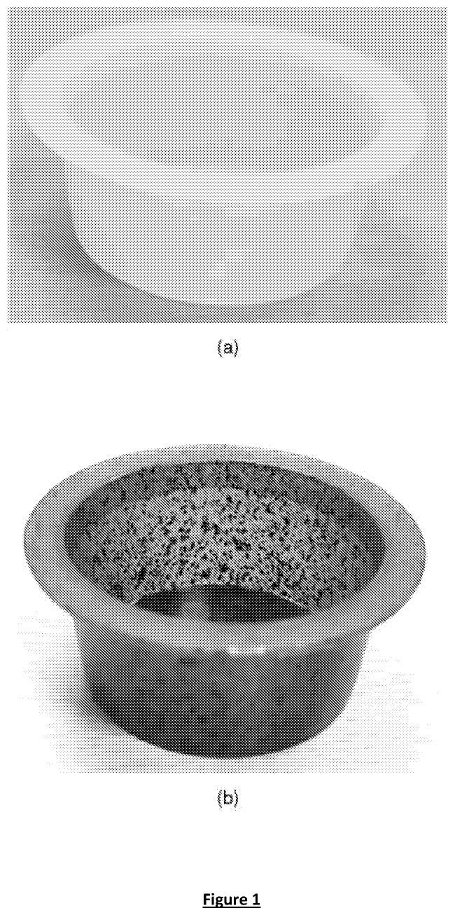

As can be seen from FIG. 1, the test was fully successful, since it was possible to produce a sample of capsule that showed sufficient rigidity characteristics for the intended use. In particular, FIG. 1(a) shows the capsule obtained with the material PP INJ and FIG. 1(b) shows the capsule obtained with the material EP 30PP 2PPgMA.

This test therefore demonstrated the possibility of effectively reusing the plastic materials resulting from the separation of spent coffee capsules to make new articles to be reintroduced into industrial supply chains. In particular, since the manufactured article is a coffee capsule, it is evident how the whole process can really give concrete form to the logic of the circular economy in the coffee sector.

### Example 4

The shredded material of Example 1 (denoted EP), obtained after separation from the spent coffee, and consisting of fragments of polypropylene, polyester, filter paper and spent coffee, containing about 87.30% by weight of polypropylene, about 11.72% by weight of spent coffee, about 0.43% by weight of filter paper and about 0.55% by weight of polyester was used to make various composites by adding as a coupling agent polypropylene grafted with maleic anhydride (PPgMA), the commercial product Polybond 3200 sold by Chem Point, and varying amounts (from 10 to 70% by weight) of spent coffee ground (SCG) from the same separation process. The various blends were prepared by simple manual mixing in drums of the various components, without any kind of pre-treatment, such as drying, and were fed directly to the Multipla 220 industrial machinery for direct extrusion tests.

The operating conditions proved to be even milder in real industrial machinability tests than those tested in pilot plants or on a laboratory scale. They operated at an injection temperature of only 165° C.

Table 5 below shows the compositional data of the blends used in the tests:

TABLE 5

| | | spent coffee | | | actual % of coffee |
|---|---|---|---|---|---|
| | | (SGC) added | | Polibond 3200 | present in the final |
| | | g (% by | | (PPgMA) g | blend considering the |
| | | weight with | | (% by weight | content of coffee |
| | | respect to | | with respect to | already present in the |
| Sample identification | Shredded | shredded | | shredded | starting shredded |
| code | (EP) g | material) | | material) | material |
| EP | 3000 | 0 | | 60 (2%) | 11.5% |
| EP 10SGC 2PPgMA | 2000 | 200 | (10%) | 40 (2%) | 19.4% |
| EP 20SGC 2PPgMA | 2000 | 400 | (20%) | 40 (2%) | 26.0% |
| EP 40SGC 2PPgMA | 2000 | 800 | (40%) | 40 (2%) | 36.4% |
| EP 70SGC 2PPgMA | 2000 | 1400 | (70%) | 40 (2%) | 47.5% |

The machine was equipped with a mold in the shape of a double jar, such as those used in the food industry for packaging ricotta, spreadable cheeses and puddings, i.e. a particularly critical shape to produce as it had some connecting parts with very thin thicknesses (less than mm).

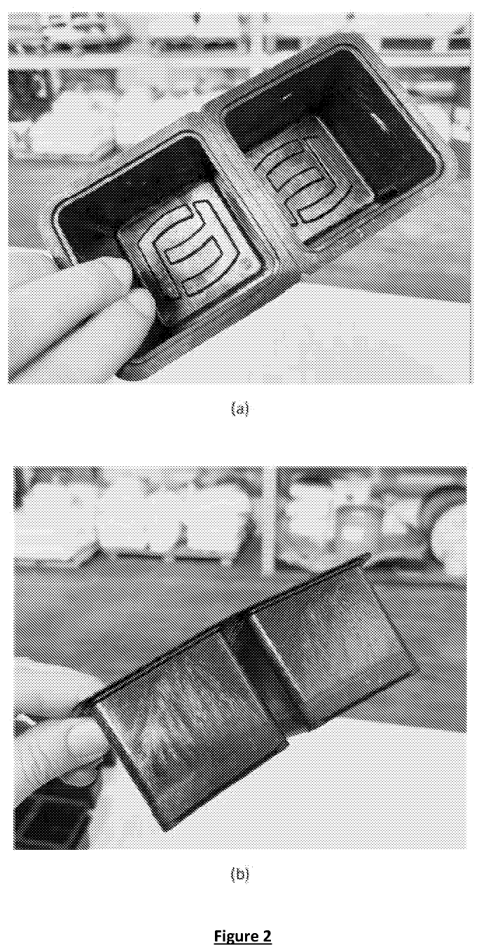

In all the cases tested, the blend was perfectly workable and the jar was perfectly made. FIG. 2 shows the frontal (2a) and side (2b) views of the jar obtained with the EP 40SGC 2PPgMA blend.

This result is to be considered surprising in view of the lessons learned in prior art, such as the description in Shayene Campos de Bomfim, A. et Al, Journal of Cleaner Production, Elsevier Amsterdam, Vol. 297, 2021, where it is stated that polypropylene compositions with 30% of spent coffee did not allow shapes with thicknesses of less than 3 mm to be made.

Even the jar with an effective coffee % of over 47% was fully processable under these conditions, although with reduced workability compared to the other blends.

The experiments conducted thus made it possible to demonstrate the surprising possibility of using the residues of spent coffee capsules after shredding and separation from the spent coffee, as recyclable polymeric materials to be used directly for the preparation of new polymer composites with mechanical properties that are fully acceptable for industrial use, overcoming the prejudices of the prior art regarding the possibility of recycling mixtures of plastics of different natures, among other things in this case also soiled with other waste, the shredded material being a mixture of plastics of different natures (polypropylene, polyester) as well as other materials (paper and spent coffee).

Tests showed that it was possible to add additional amounts of spent coffee to the shredded material without compromising, and indeed improving, the properties of the final composite, and that the best performing compositions could be obtained using PPgMA as the coupling agent.

Therefore, the inventors have surprisingly demonstrated that it is possible to completely recycle plastics directly obtained from spent coffee capsules, even those containing significant amounts of spent coffee as impurities, without any need for time-consuming and expensive separation and purification, contrary to what was described and suggested in the prior art.

Finally, the use of an additional PP polymer with a maximum tensile strength of between 15 and 45 MPa, mixed with the shredded material, improved its processability, resulting in a new composite with excellent mechanical and rheological properties, which could even be used to make new capsules. The use at industrial level of, for example, the composite of Example 2, containing only about 30% by weight of virgin polypropylene, would obviously make it possible to greatly reduce the use and consumption of virgin plastics and to absorb considerable quantities of plastics already circulating as waste, thus realising evident and important benefits from an environmental point of view, as well as significant savings in raw materials at industrial level.

1. A method for the preparation of a recycled polymeric material comprising the steps of:
(a) preparing a material obtained by shredding spent coffee capsules comprising polypropylene particles, coffee in an amount from 5 to 70% by weight with respect to the total weight of the material, and particles of at least one residue selected from the group consisting of: paper, one or more polymers other than polypropylene, aluminium, and mixtures thereof;
(b) mixing the material from step (a) with at least one coupling agent thus obtaining the recycled polymeric material.

2. The method according to claim 1, wherein in said step a) the amount of said coffee is in the range from 10 to 50% by weight with respect to the total weight of the material.

3. The method according to claim 1, wherein in said step a) said one or more polymers other than polypropylene are selected from the group consisting of: polyethylene (PE), polyethylene terephthalate (PET), polybutylene terephthalate (PBT), a polyester other than PET and PBT, and ethylene-vinyl alcohol copolymer (EVOH).

4. The method according to claim 1, wherein in said step b) the amount of said at least one coupling agent varies from 0.5 to 4.5% by weight, with respect to the total weight of the at least one shredded material, preferably is about 2% by weight.

5. The method according to claim 1, wherein in said step b) said at least one coupling agent is selected from the group consisting of: a silane, a polymer functionalized with maleic anhydride or with methacrylate glycides, preferably it is 3-aminopropyltriethoxy-silane or polypropylene grafted with maleic anhydride.

6. The method according to claim 1, wherein in step b) at least one polypropylene having a maximum tensile strength in the range from 15 to 45 MPa is also added.

7. The method according to claim 6, wherein in step b) said polypropylene is added in an amount from 30 to 60% by weight with respect to the total weight of the material obtained from the shredding of spent coffee capsules of step a).

8. A recycled polymeric material comprising a matrix (continuous phase) comprising polypropylene from spent coffee capsules coupled with at least one coupling agent, and a dispersed phase comprising spent coffee particles and other residues selected from the group consisting of: paper, one or more polymers other than polypropylene, aluminium, and mixtures thereof.

9. The recycled polymeric material according to claim 8, wherein the matrix comprises polypropylene from spent coffee capsules coupled with at least one coupling agent, wherein the weight ratio of polypropylene:coupling agent is in the range from 50:4.5 to 95:0.5.

10. The recycled polymeric material according to claim 8 wherein said dispersed phase comprises spent coffee particles in an amount from 5 to 70% by weight, preferably from 10 to 50% by weight.

11. The recycled polymeric material according to claim 8 wherein the residue is paper, preferably in an amount of up to 2% by weight with respect to the weight of the material.

12. The recycled polymeric material according to claim 8 wherein the residue is a polymer other than polypropylene, preferably selected from the group consisting of: polyethylene (PE), polyethylene terephthalate (PET), polybutylene terephthalate (PBT), a polyester other than PET and PBT, and ethylene-vinyl alcohol copolymer (EVOH), preferably in an amount from 0.1 to 25% by weight, more preferably from 0.1 to 3% by weight.

13. The recycled polymeric material according to claim 8, further comprising at least one polypropylene having a maximum tensile strength in the range from 15 to 45 MPa.

14. The recycled polymeric material according to claim 13 wherein said at least one polypropylene having a maximum tensile strength in the range from 15 to 45 MPa is present in an amount from 30 to 60% by weight, with respect to the total weight of the material.

15-18. (canceled)
